(19) United States
(12) Patent Application Publication
(10) Pub. No.: US 2002/0030731 A1
(43) Pub. Date: Mar. 14, 2002

(54) Thermal printer

(76) Inventors: Hisashi Yahagi, Tokyo (JP); Yoshinobu Nagasaki, Tokyo (JP); Masahiko Ueda, Tokyo (JP)

Correspondence Address: Smith, Gambrell & Russell, LLP, Beveridge, DeGrandi, Weilacher & Young, Intellectual Property Group, 1850 M Street N.W., Suite 800, Washington, DC, 20036, US

(21) Appl. No.: 09/949,839

(22) Filed: Sep. 12, 2001

(30) Foreign Application Priority Data
Sep. 12, 2000 (JP) 276509/2000

(51) Int. Cl. B41J 2/325

(52) U.S. Cl. 347/218

(57) ABSTRACT

A thermal head is supported by a head arm which can move between a position where it is close to a platen and a position where it is apart from the platen. The thermal head is configured such that it can move between a printing position where a sheet and an ink ribbon are pushed against the platen and a retracted position where the ink ribbon is spaced from the platen sot that the ink ribbon is spaced from the sheet. The thermal head moves between the printing position and the retracted position by a cam mechanism, for example. Such a mechanism is effective, for example, in allowing only a sheet to feed, preventing wasteful feeding of an ink ribbon.

### BACKGROUND OF THE INVENTION

1. Field of the invention

The present invention relates to improvement of a printing portion in a thermal printer.

2. Description of the Prior Art

In a line thermal printer, printing is performed such that, in a state where a platen and a line thermal head are opposed to each other, a heat-sensitive paper is, or a heat-sensitive ribbon and a paper superimposed on each other are, caused to pass in between the platen and the line thermal head. At the time of printing, it is important for maintaining printing quality in a high level that the line thermal head applies proper contacting pressure to the platen via the heat-sensitive paper, or the ink ribbon and the paper. On the other hand, when printing is performed using the ink ribbon, a so-called ribbon saving is performed to prevent a wasteful consumption of an ink ribbon by feeding only a paper, not feeding an ink ribbon, when receiving a printing signal indicating that only a paper be fed without printing.

As an ink ribbon is pressed against a paper at suitable pressure by a platen and thermal head when printing is performed, a strong friction generates between the ink ribbon and the paper, so that it is impossible to feed only a paper without feeding the ink ribbon.

For the above reason, the ribbon saving mechanism actuates a solenoid based on the printing signal indicating an empty line or an empty column to separate a line thermal head from the platen via a lever or to separate the platen from the thermal head.

Conventionally, since such a structure is employed that a whole head arm including a peripheral mechanism for supporting the line thermal head together with the head is also ascended/descended, the machine or apparatus itself is large-sized, which results in difficulty of rapid operation. Also, the ascending/descending of the entire head to be effected by using the solenoid can be performed securely, but the operation is linear and an impact may occur at an end point(retracted position) of operation for separating the line thermal head from the platen or at an end point (printing position) of operation for causing the line thermal head and the platen to approach to each other. As a result, there may occur a drawback that the thermal head supporting mechanism go out of order so that printing quality is adversely affected.

### SUMMARY OF THE INVENTION

In accordance with an aspect of the present invention, a thermal printer is provided with a platen, a head arm and a line thermal head. The head arm holds the line thermal head. The head arm can move relative to a main body from between a first position (a set position where printing can be made on a paper) where the line thermal head is caused to approach to the platen and a second position (an open position where loading of a sheet is not obstructed) where the line thermal head is separated from the platen.

Such a structure can further be employed that, when the head arm is in the first position, the line thermal head mounted on the head arm can move between (1) a printing position where the line thermal head is brought in pressure-contact with the platen through a sheet and an ink ribbon and (2) a retracted position where the line thermal head is separated from a platen by a distance so as to forms a gap or clearance between the ink ribbon and the sheet on the platen.

In addition to the above-described structure, the following configurations may by applied to the present invention.

As a specific configuration, the thermal printer is provided with a paper or sheet feeding path for allowing the paper and the ink ribbon to pass in between the platen and the line thermal head in a superimposed manner, a sheet feeding mechanism for feeding a paper, and an ink ribbon feeding mechanism for feeding the ink ribbon. When only the paper is fed, the line thermal head is moved to the retracted position.

As a configuration for moving the line thermal head between the printing position and the retracted position by using a stepping motor and a cam mechanism, it is preferable to select a cam curve, since impact can be reduced to almost zero at the end point of the movement of the line thermal head between the printing position and the retracted point.

Also, such a structure can be employed that the line thermal head is slidably supported by a head frame supported by the head arm in upward and downward directions, and the head frame is moved by the cam without employing a structure where the line thermal head and the cam are brought into direct contact with each other. Since mounting work or exchanging work of the line thermal head can be facilitated and there is not any influence of the standard and/or size of the line thermal head, a contacting position of the line thermal head with the cam can be set relatively freely.

The line thermal head is urged towards the platen by a resilient member such as a compression spring from the head arm to maintain a proper contacting pressure at the printing position.

### BRIEF DESCRIPTION OF THE DRAWINGS

The above object and features, and other object and features will become apparent from the following explanation of an embodiment with reference to the accompanying drawings, wherein:

FIG. 1 is a schematic front view showing an arrangement of constituent elements of a line thermal printer according to the present invention in a housing from which a cover is removed;

FIG. 2 is a perspective view of the line thermal printer shown in FIG. 1, where its head arm is in a first position;

FIG. 3 is a perspective view of the line thermal printer shown in FIG. 1, where its head arm is in a second position;

FIG. 4 is a front view showing a schematic configuration of a head set when the head arm is in the second position;

FIG. 5 is a front view showing a schematic configuration of the head set when the head arm is in the first position;

FIG. 6 is a schematic front view for explaining that a line thermal head is put in a printing position close to a platen by a cam of a driving mechanism for ribbon saving; and

FIG. 7 is a schematic front view for explaining that the line thermal head is put in a retracted position separated from the platen by the cam of the driving mechanism for ribbon saving.

### DETAILED DESCRIPTION OF THE PREFERRED EMBODIMENTS

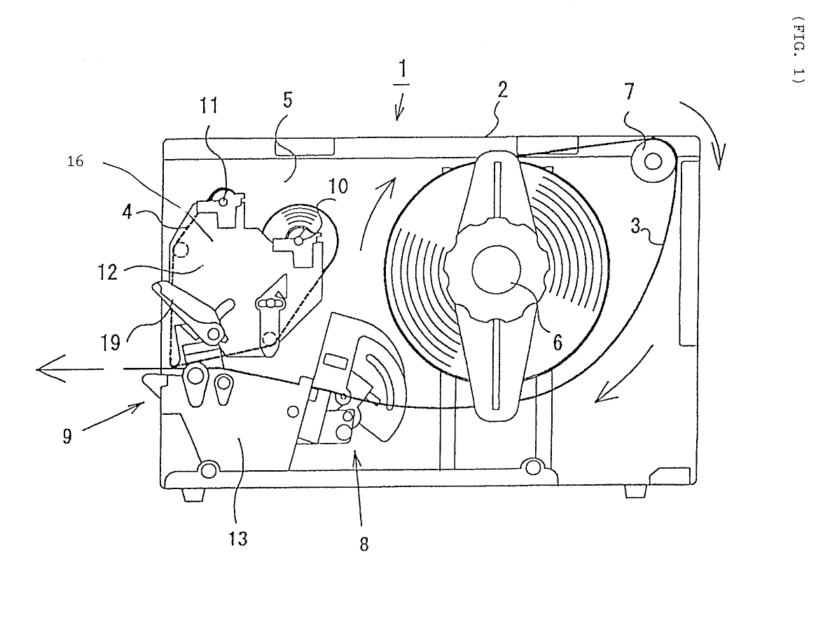

FIG. 1 is a schematic configuration of a line thermal printer 1 according to an embodiment of the present invention, wherein a cover is removed from a casing 2. In the line thermal printer 1 shown in FIG. 1, a sheet 3 and a heat-sensitive ink ribbon 4 are loaded.

In the casing 2, its space is partitioned into two interior spaces vertically by a partition wall 5. Supported to this partition wall 5 are a roll supporting shaft 6, a supporting shaft of a tension roller 7, a ribbon shaft 10 on the feeding side, and a ribbon shaft 11 on the winding side. Also, a sheet feeding mechanism 8 and a printing section 9 are provided on a front side of the partition wall 5. Arranged on a back side of this partition wall 5 are a driving mechanism such as gears and the like for driving elements, such as the sheet feeding mechanism 8, the printing section 9 and the like and a control mechanism.

A sheet 3 fed from a sheet roll loaded on the roll supporting shaft 6 passes between an upper main body frame 12 and a lower main body frame 13 outside from the housing 2 via the tension roller 7 and the sheet feeding mechanism 8. In a course of the feeding path of the sheet 3, various guides (not shown), rollers (not shown) provided at a position for converting a feeding direction of the paper and the like exist in a conventional manner.

Incidentally, these upper main body frame 12 and lower main body frame 13 are constituting elements for the printing section described later and they are fixed to the partition wall 5.

A mechanism for feeding the ink ribbon 4 includes the ribbon shaft 10 on the feeding side and the ribbon shaft 11 on the winding side. Guide rollers and rollers (not shown) for guiding the ink ribbon exist in the feeding path of the ink ribbon 4.

The feeding path of the sheet 3 and the feeding path of the ink ribbon 4 are combined at a position where the upper main body frame 12 and the lower main body frame 13 are opposed to each other, and the sheet 3 and ink ribbon 4 are superimposed to pass between the upper main body frame and the lower main body frame.

The roll formed by rolling the sheet 3 can easily be attached/detached to the roll supporting shaft 6 manually. The tension roller 7 is made of synthetic resin sponge and friction occurs between the tension roller 7 and the sheet 3. When tension acting on the paper is increased, the tension is absorbed by deformation of the section area of the tension roller 7 due to softness or flexibility thereof, thereby preventing the sheet 3 from being damaged.

The sheet feeding mechanism 8 is provided with a feed roller, a guide roller, and pinch rollers arranged so as to be opposed to these feed roller and guide roller vertically, (which are not illustrated in detailed). The sheet 3 is fed towards the printing section 9 while passing between the feed roller and the pinch roller.

The upper main body frame 12 and the lower main body frame 13 are fixed on the partition wall 5 so as to be opposed to each other in a vertical direction. A head set 14 is arranged to the upper main body frame 12 and a platen 15 is disposed on the lower main body frame 13.

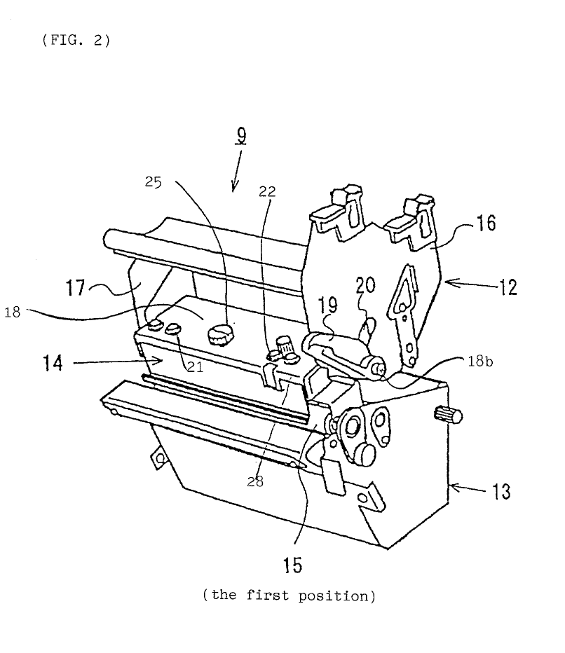

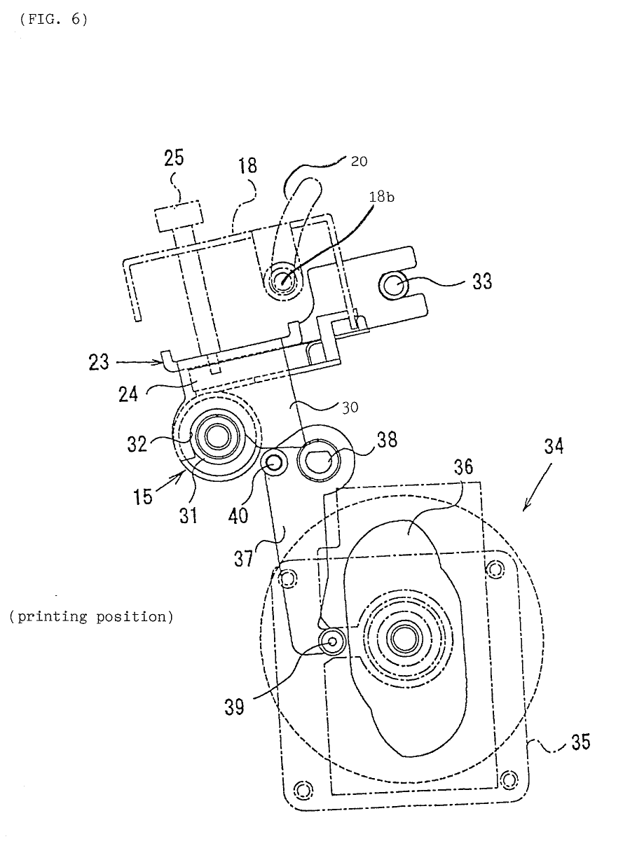

The upper main body frame 12 is provided with right and left frame walls 16, 17 parallel to each other, as shown in FIG. 2. A head arm 18 which is one constituting element of the head set 14 is mounted between the left frame wall 16 and the right frame wall 17 so as to be rotatable about a shaft 33 (FIG. 6). Arc-shaped slots 20 are respectively formed on the left and right frame walls 16, 17, and supporting shafts 18b projecting from the left and right sides of the head arm 18 project from these slots 20. Portions of the supporting shafts 18b projecting from the slots 20 to the outside are fixed with operation levers 19.

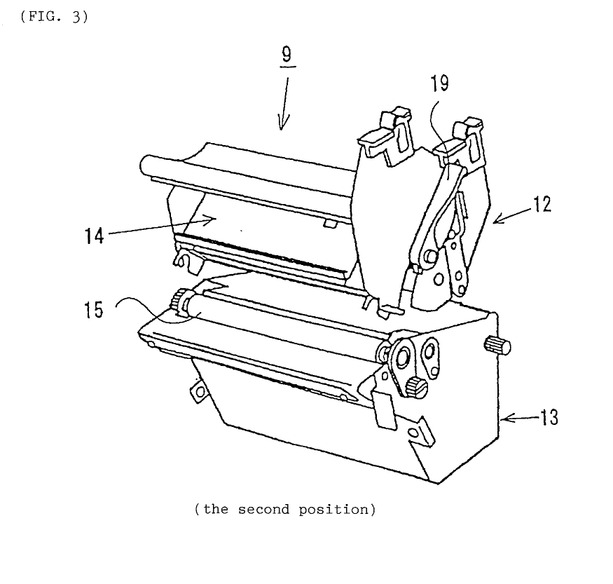

When the operation lever 19 is positioned at a lower end portion of the slot 20, as shown in FIG. 2, the head arm 18 is put in a “first position” close to the platen 15. At this position, printing on the sheet 3 can be made possible. Also, when the head set 14 is ascended from the position shown in FIG. 2 to an upper end portion of the slot 20 along the longitudinal direction of the slot 20 by operating the operation lever 19, as shown in FIG. 3, the head arm 18 comes to a “second position” separated from the platen 15. At this position, it becomes possible to load the sheet 3.

A holding mechanism is provided such that, when the head arm 18 is in the first position and also when it is in the second position, the head arm 18 are held in the respective positions due to the own weight of the head set 14.

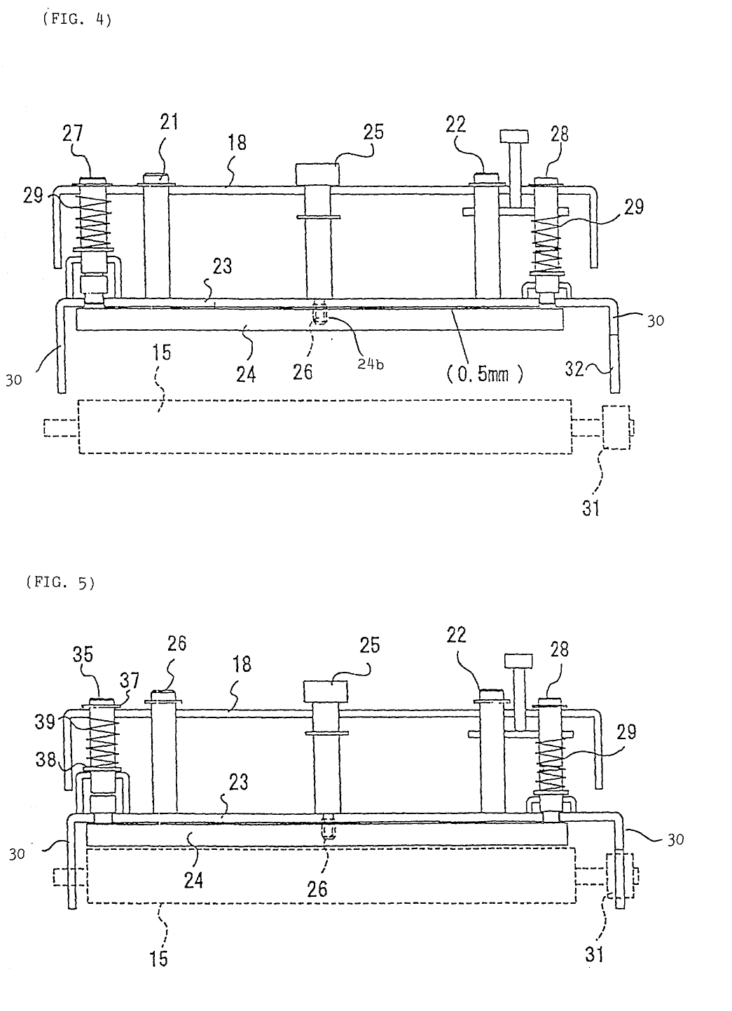

As shown in FIGS. 4 and 5, supporting pins 21, 22 which are spaced from each other in a horizontal direction so as to be slidable downward, namely towards the platen 15, are provided on the head arm 18. Fixed to lower ends of the supporting pins 21, 22 is a head frame 23. Stopper rings are respectively fixed to upper portions of the supporting pins 21, 22, so that the supporting pins are prevented from falling off from the head arm 18.

Furthermore, a mounting pin 25 is mounted on a central portion of the head arm 18 so as to be slidable downward. A male screw 26 with a small diameter formed at a lower end of the mounting pin 25 penetrates a central portion of the head frame 23 to engage a female screw 24b formed on a central portion of the line thermal head 24 arranged on a lower face side of the head frame 23 in a threading manner.

Incidentally, the length of the female screw 24 is determined such that, when the male screw 26 is screwed into the female screw 24b of the line thermal head 24, a gap or clearance of about 0.5 mm occurs between the head frame 23 and the line thermal head 24 necessarily. As a result, left and right ends of the line thermal head 24 can swing vertically about a portion which is supported by the male screw 26 utilizing this gap with the head frame 23.

Furthermore, pressing pins 27, 28 are mounted in the vicinities of left and right end portions of the head arm 18 so as to be slidable downward. End portions of the pressing pins 27, 28 penetrate through holes formed in the head frame 23 to face the line thermal head 24. Compression springs 29 are fitted on the pushing pins 27, 28. At a time of printing operation, the compression springs 29 push the pushing pins 27, 28 downward so that the lower ends of the pushing pins 27, 28 directly push the line thermal head 24 downward. For this reason, the line thermal head 24 is brought in pressure-contact with the platen 15.

When the head arm 18 is rotated downward to be positioned at the first position (FIG. 2), the line thermal head 24 is close to the platen 15 and the lower ends of the pushing pins 27, 28 abut on the thermal line head 24, as shown in FIG. 5.

On the other hand, when the head arm 18 is rotated upward to be positioned at the second position (FIG. 3), the line thermal head 24 is separated from the platen 15 and the lower ends of the pushing pins 27, 28 are separated from the line thermal head 24, as shown in FIG. 4. The head frame 24 put in this state is suspended from the head arm 18 via the mounting pin 25, as shown in FIG. 4.

The head frame 23 is formed at its left and right ends with bent portions 30 extending vertically downward in a suspending manner. The right bent portion 30 is provided with a recessed portion 32 engaging a positioning ring 31 arranged at a right end portion of the platen 15, as shown in FIGS. 4 and 6.

Also, the line thermal head 24 is mounted on a front face of a front portion of the head frame 23, and a rear portion of the head frame 23 is engaged with a shaft 33 provided to the head arm 18. Accordingly, when the head arm 18 is rotated about the shaft 33, the head frame 23 suspended from the head arm 18 via the mounting pin 25 is also rotated about the shaft 33.

As shown in FIG. 6, the driving mechanism 34 for ribbon saving is provided on the lower main body frame 13, and it has a plate cam 36 and a lever 37 driven by a stepping motor 35. The lever 37 is rotatably supported to a shaft 38 fixed to the lower main body frame 13. A first cam follower 39 is provided at a lower end portion of the lever 37, and a second cam follower 40 is provided at a upper end portion thereof. A portion of the lever 37 which is supported by the shaft 38 is positioned on an upper end rear side, and a portion of the lever which is provided with the second cam follower 40 is positioned on an upper end front side.

The second cam follower 40 of the lever 37 comes in contact with a lower end of the right side bent portion 30 of the head frame 24. At this time, biasing or urging forces of the compression springs 29 fitted on the pushing pins 27, 28 serve so as to push the bent portion 30 against the second cam follower 40.

When the plate cam 36 is rotated, the lever 37 is rotated in a clockwise direction on FIG. 6 so that the second cam follower 40 pushes up the head frame 23. Also, the pushing pins 27, 28 push the line thermal head 24 by the urging forces of the compression springs 29 so that the head frame 23 which has been pushed up is returned back to its original or home position. A cam curve of the plate cam 36 is set so as to allow the above operations. The shape (cam curve) of the plate cam 36 is set to be a smooth curve wholly, thereby preventing impact from occurring on rotation of the lever 37.

Since the distance between the rotating shaft 38 and the second cam follower 40 is significantly shorter than the distance between the first cam follower 39 and the rotating shaft 38, the second cam follower 40 can ascend or elevate a relatively heavy assembly of the line thermal head 24 and the head frame 24 via the right bent portion 30 of the head frame 23 lightly and smoothly.

When the head arm 18 is in the first position (FIG. 2) and the plate cam 36 in the driving mechanism 34 for ribbon saving is in the rotated position shown in FIG. 6, the head frame 23 is biased by the biasing forces of the compression springs 29 fitted on the pushing pins 27, 28 to be positioned at the lowermost position, and the sheet 3 and the ink ribbon 4 are in a pressure-contact state with the platen. That is, the line thermal head 24 is in the “printing position” where printing is performed.

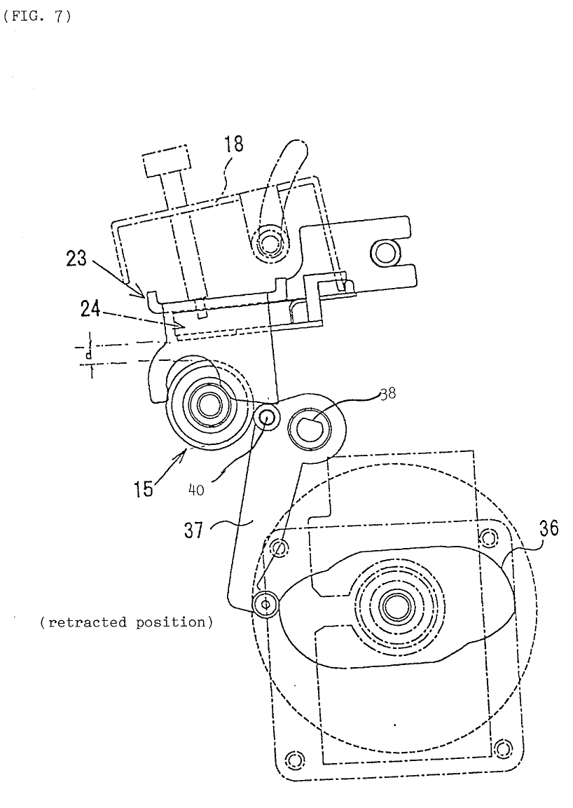

When the plate cam 36 is rotated by 90° from the rotated position shown in FIG. 6 in a clockwise direction and the lever 37 is in an attitude shown in FIG. 7 obtained when it is rotated by a certain angle from the position shown in FIG. 6 in a clockwise direction, the second cam follower 40 reaches an ascended position (a position higher than the lever rotating shaft 38) which is higher than the position from the position shown in FIG. 6 (height which is approximately equal to the height of the lever rotating shaft 38). That is, FIG. 7 shows a state where the line thermal head 24 is in the “retracted position” obtained by pushing-up of the head frame 23 conducted by the ascended second cam follower 40 via the right bent portion 30 of the head frame 23.

As shown in FIG. 7, a gap d occurs between the line thermal head 24 positioned at the retracted position and the platen 5, and the pressure-contact between the sheet 3 and the ink ribbon 4 has been released. Therefore, such a ribbon saving operation can be performed that only the sheet 3 is fed by the sheet feeding mechanism 8 and a wasteful feeding of the ink ribbon 4 is prevented.

The pinch roller of the sheet feeding mechanism 8 is ascended upwardly. Then, the operation lever 19 in the printing section 9 is rotated upwardly to put the head arm 18 in the second position (FIG. 3) so that a gap occurs between the head set 14 and the platen 15. Subsequently, the sheet 3 is loaded by turning the same as shown in FIG. 1. Furthermore, the rolled heat-sensitive ribbon 4 loaded to the ribbon shaft 10 on the feeding side is caused to pass between the line thermal head 24 in the printing section 29 and the platen 15 to be attached to the winding side ribbon shaft 11 opposed to the shaft 10.

Then, the operation lever 19 is rotated downwardly to descend the head set 14 and the head arm 18 is put in the first position (FIG. 2). Thereby, the sheet 3 and ink ribbon 4 are superimposed to be brought into pressure-contact with each other between the line thermal head 24 and the platen 15. The driving mechanism 34 for ribbon saving puts the plate cam 36 in a position corresponding to the printing position (FIG. 6). In this state, the sheet 3 and the ink ribbon 4 are fed according to a printing signal from the control device (not shown), and simultaneously printing is performed by the line thermal head 24.

Then, when a printing signal for an empty line or an empty field or column is output, the stepping motor 35 is driven to rotate the plate cam 36 by 90° so that the line thermal head 34 is positioned in the retracted position shown in FIG. 7. Then, the plate cam 36 is further rotated 90° according to the next real printing signal to put the line thermal head 24 in the printing position where printing is restarted.

As mentioned above, the printing and the ribbon saving are performed.

In the above, regarding the ribbon saving, the embodiment where the line thermal head 24 is moved to the printing position and the retracted position has been explained. As another system, such a configuration can be employed that the lowering or descending position of the head frame 23 is restricted and simultaneously a platen shaft is pivoted to an upper end of the lever 37 in the driving mechanism 34 so that the platen 15 is moved by rotation of the plate cam 36 upward and downward (to the printing position and the retracted position) relative to the line thermal head 24 positioned at the above lower limit position.

Incidentally, the cam for moving the lever 37 is not limited to the plate cam but it may take such a form as a cam groove or an eccentric plate.

According to the present invention, since the ribbon saving is performed by the cam operation, impact hardly occurs when the line thermal head is moved to the printing position or when it is moved to the retracted position. As a result, there does not occur such a drawback that adjusted position is displaced in the mechanism for ribbon saving, and an excellent printing quality can be maintained.

Since the mechanism for separating the head arm from the platen when the paper and the ink ribbon are set and the mechanism for slightly separating the head frame from the platen for ribbon saving are separated from each other, the mechanism for ribbon saving can be small-sized and faster operation can be made possible.

1. A thermal printer, comprising:
a platen;
a thermal head; and
a head arm,
the head arm being movable between a first position where it is close to the platen and a second position where it is spaced from the platen, wherein,
when the head arm is in the first position, a configuration is employed that the thermal head is movable between a printing position where the thermal head comes in close contact with the platen and a retracted position where the thermal head is spaced from the platen with a predetermined space.

2. The thermal printer according to claim 1, further comprising a sheet feeding path for allowing a sheet and an ink ribbon superimposed on each other to pass in between the platen and the thermal head; a sheet feeding mechanism for feeding the sheet; and an ink ribbon feeding mechanism for feeding the ink ribbon, wherein, when only the paper is fed, the thermal head is shifted to the retracted position.

3. The thermal printer according to claim 2, wherein the thermal head performs printing for every at least one line in the direction perpendicular to the sheet feeding direction.

4. The thermal printer according to claim 3, wherein the line thermal head is biased toward the platen side by the head arm via a resilient member.

5. The thermal printer according to claim 4, further comprising a holding mechanism for holding the head arm at the first position.

6. The thermal printer according to claim 4, wherein the resilient member is a compression coil spring arranged between the thermal head and the head arm.

7. The thermal printer according to claim 1, wherein the thermal head is constituted to be movable between the printing position and the retracted position by means of a cam mechanism.

8. The thermal printer according to claim 7, wherein the thermal head is supported by a head frame, and the head frame is caused to abut on the cam mechanism.

9. The thermal printer according to claim 8, wherein the cam mechanism is driven by a stepping motor.

10. A thermal printer, comprising:
a platen;
a thermal head;
sheet feeding mechanism for feeding a sheet between the platen and the thermal head;
ink ribbon feeding mechanism for feeding the ink ribbon by unwinding the ink ribbon from a shaft on which the ink ribbon is wound, causing the ink ribbon to pass in between the thermal head and the sheet, and winding the ink ribbon round a winding shaft.
a head arm supporting the thermal head through a resilient member; and
a driving mechanism for moving the thermal head from a printing position where the sheet and the ink ribbon are pressed against the platen to a retracted position where the ink ribbon is spaced from the face of the sheet against the biasing force of the resilient member; wherein
when feeding only the sheet without printing it, the thermal head is spaced from the platen by the driving mechanism, and the sheet is fed by the sheet feeding mechanism in a state where the ink ribbon feeding mechanism is stopped.

11. The thermal printer according to claim 10, wherein the driving mechanism comprising a cam and a motor for driving the cam to rotate.

12. The thermal printer according to claim 11, wherein the driving mechanism is arranged on a side of the platen opposite the thermal head.

13. The thermal printer according to claim 12, wherein the sheet is a label paper in which a label is mounted on a rolled long pasteboard.

14. The thermal printer according to any one of claims 10 to 13, wherein the thermal head performs printing for every at least one line in the direction perpendicular to the sheet feeding direction.

15. A thermal printer, comprising:
a platen;
a line thermal head;
sheet feeding mechanism for feeding a sheet between the platen and the line thermal head;
ink ribbon feeding mechanism for feeding the ink ribbon by unwinding the ink ribbon from a shaft on which the ink ribbon is wound, causing the ink ribbon to pass in between the thermal head and the sheet, and winding the ink ribbon round a winding shaft.
a head arm which is movable between a first position where the head arm is close to the platen and a second position where the head arm is spaced from the platen,
a resilient member, arranged between the head arm and the line thermal head, which urges the thermal head toward the platen side;
a driving mechanism, arranged below the platen, which moves the thermal head from a printing position where the sheet and the ink ribbon are pressed against the platen to a retracted position where the ink ribbon is spaced from the face of the sheet against the biasing force of the resilient member; wherein,
when feeding only the sheet without printing it while the head arm is in the first position, the line thermal head is spaced from the platen by the driving mechanism, and the sheet is fed by the sheet feeding mechanism in a state where the ink ribbon feeding mechanism is stopped.
